(19) United States
(12) Patent Application Publication
(10) Pub. No.: US 2006/0260134 A1
(43) Pub. Date: Nov. 23, 2006

(54) Egg cracking apparatus

(76) Inventors: William Kolano, Pittsburg, PA (US); Chervin Chow, Evansion, IL (US); Dorothea Li Feng Koh, Evansion, IL (US); Edwin Tze Meng Lim, Singapore (SG); Zhiyong Poon, Evansion, IL (US); Peter Konrad Eck, Lake Bluff, IL (US); Jeffrey Scott Miller, Fargo, ND (US)

Correspondence Address: STRIKER, STRIKER & STENBY, 103 EAST NECK ROAD, HUNTINGTON, NY, 11743, US

(21) Appl. No.: 11/336,364

(22) Filed: Jan. 20, 2006

Related U.S. Application Data
(60) Provisional application No. 60/645,887, filed on Jan. 21, 2005.

(51) Int. Cl. B26B 17/00; A23N 5/00

(52) U.S. Cl. 30/120.1

(57) ABSTRACT

An egg cracking apparatus has a base provided with an egg cracking element, a bottom lid having an opening for receiving an egg and being connected with the base pivotally between a first position in which it is pivoted away from the base and a second position in which it is located close to the base, and a top lid connected with the bottom lid pivotally between a first position in which it is pivoted away from the bottom lid and a second position in which it is located close to the bottom lid, so that when in the first position of the bottom lid an egg is placed in the opening of the bottom lid and the top lid is pivoted from the first position of the top lid to the second position of the top lid, and both lids are pivoted from the first position of the bottom lid to the second position of the bottom lid, and add located in the bottom lid is pressed by the top lid toward the egg cracking element and is cracked by the egg cracking element.

### BACKGROUND OF THE INVENTION

The present invention relates to egg cracking apparatuses.

Egg cracking apparatuses of various designs are known in the art. It is believed that the existing egg cracking apparatuses can be improved so as to make easier operation of the apparatus without a complicated movements, to minimize any potential risks of physical injury, and to reduce accidental trapping of shells and yoke which are difficult to spot and clean.

### SUMMARY OF THE INVENTION

Accordingly, it is an object of the present invention to provide an egg cracking apparatus, which is a further improvement of the existing egg cracking apparatuses.

In keeping with these objects and with others which will become apparent hereinafter, one feature of the present invention resides, briefly stated, in an egg cracking apparatus, comprising a base provided with an egg cracking element; a bottom lid having an opening for receiving an egg and being connected with said base pivotally between a first position in which it is pivoted away from said base and a second position in which it is located close to said base; and a top lid connected with said bottom lid pivotally between a first position in which it is pivoted away from said bottom lid and a second position in which it is located close to said bottom lid, so that when in said first position of said bottom lid an egg is placed in said opening of said bottom lid and said top lid is pivoted from said first position of said top lid to said second position of said top lid and, both lids are pivoted to said second position of said bottom lid, the egg located in said bottom lid is pressed by said top lid toward said egg cracking element and is cracked by said egg cracking element.

When the egg cracking apparatus is designed in accordance with the present invention, it constitutes an improvement over the existing egg cracking apparatuses. Its operation is easy and simple, a risk of physical injury is minimal, and components of eggs are easily evacuated.

The novel features which are considered as characteristic for the present invention are set forth in particular in the appended claims. the invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIGS. 1, 2 and 3 are schematic side views of an inventive egg cracking apparatus in a position in which the apparatus is closed and no egg is introduced, in a position in which two lids of the apparatus are open and an egg is introduced into a bottom lid, and in a position in which the apparatus are closed and the egg is cracked;

FIG. 4 is a plane view of the egg cracking apparatus in the position shown in FIG. 1;

FIG. 5 is plane view of the inventive egg cracking apparatus with a top lid in an open position;

FIG. 6 is a plane view of the egg cracking apparatus in a position with both lids open; and

FIG. 7 is a cross section of the inventive egg cracking apparatus taken in FIG. 3.

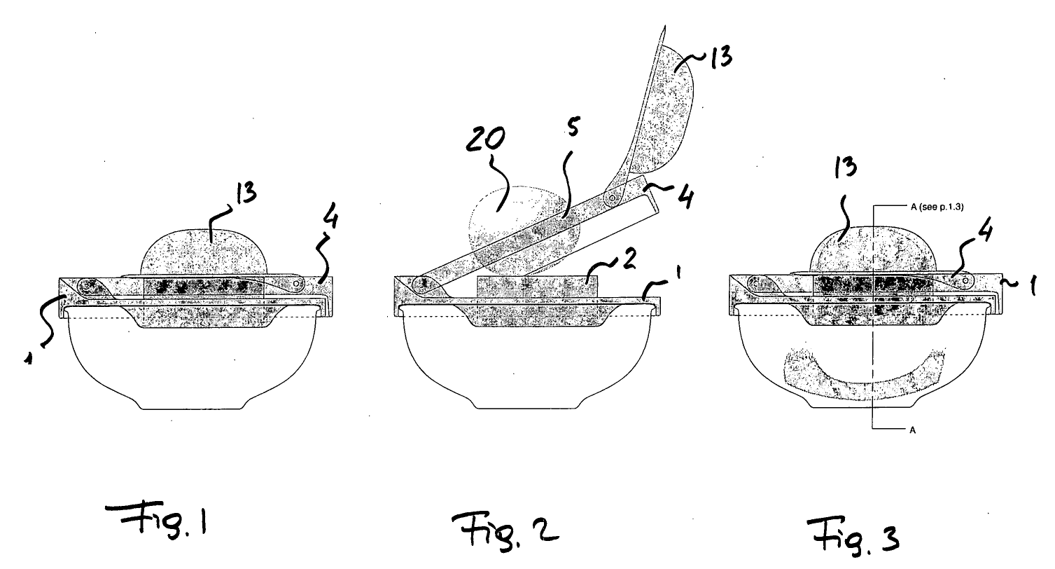

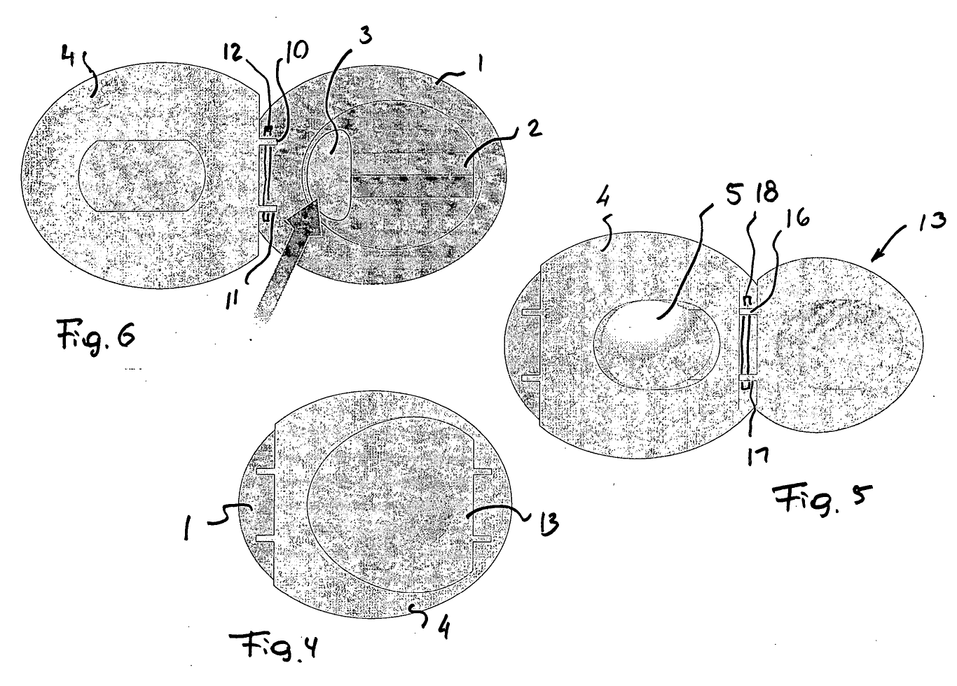

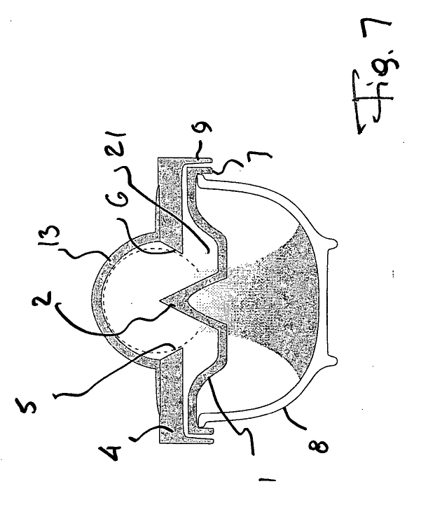

### DESCRIPTION OF THE PREFERRED EMBODIMENTS

An egg breaking apparatus in accordance with the present invention has a base which is identified with reference numeral 1. The base 1 can be substantially elongated and formed for example oval-shaped.

An elongated breaking element 2 is provided on the base 1, and can be formed of one piece with the base as clearly shown in FIG. 7. The breaking element 2 can be formed for example as an upwardly extending projection with a longitudinal sharp edge. A throughgoing opening 3 is provided in the base. The throughgoing opening 3 can be located in an area where the breaking element 2 does not extend, for example, in a region of one end of the breaking element 2.

The egg cracking apparatus has a lower lid identified with reference numeral 4. It is also elongated, similarly to the base 1 and has a throughgoing opening 5. The opening 5 can have a substantially oval shape. It can be formed with downwardly inclined shoulders 6 formed so as to support an egg. While the base 1 has a flange 7 adapted to be seated on an edge of a bowl 8, the lower lid 4 has a flange 9 which is formed so as to surround the flange 7 of the base 1 and to be seated on it.

First pivot means are provided for pivotally connecting the lower lid 4 to the base 1. The first pivot means can include lugs 10 formed on the lower lid 4 and extending through openings 11 in the base 1, and a pivot pin 12 extending through aligned openings in the lugs 10 and in the base 1, so as to pivotally connect the lower lid 4 to the base 1.

The egg cracking apparatus further has a top lid which is identified with reference numeral 13. The top lid has a central upwardly extending dome shaped part 14 and a remaining part 15 which is pivotally connected to the lower lid 4. Second pivot means are providing for pivotally connecting the top lid 13 to the bottom lid 4. The second pivot means can include lugs 16 provided in the top lid 13 and extending in openings 17 of the bottom lid 4, and a pin 18 extending through the aligned openings of the lugs 16 of the top lid 13 and the openings 17 of the bottom lid 14, so as to pivot the top lid 13 relative to the bottom lid 4.

The inventive egg cracking apparatus operates in the following manner:

When it is necessary to crack an egg, the bottom lid 4 is turned away from the base 1, for example at an acute angle and the top lid 13 is turned away from the bottom lid 4 as shown in FIG. 2. The egg 20 is inserted into the opening 5 of the top lid 4 and held on the shoulders 6. Then the top lid 13 is pivoted toward the bottom lid 4 and pressed downwardly together with the bottom lid 4, so that the egg 20 comes into contact with the cracking element 2 and is thereby cracked. The egg shells are retained on the upper surface of the base or more particularly in a small receptacle 21 formed in it, while the egg yoke and white flow through the opening 3 into the bowl 8.

It will be understood that each of the elements described above, or two or more together, may also find a useful application in other types of constructions differing from the types described above.

While the invention has been illustrated and described as embodied in, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims.

1. An egg cracking apparatus, comprising a base provided with an egg cracking element; a bottom lid having an opening for receiving an egg and being connected with said base pivotally between a first position in which it is pivoted away from said base and a second position in which it is located close to said base; and a top lid connected with said bottom lid pivotally between a first position in which it is pivoted away from said bottom lid and a second position in which it is located close to said bottom lid, so that when in said first position of said bottom lid an egg is placed in said opening of said bottom lid and said top lid is pivoted from said first position of said top lid to said second position of said top lid, and both lids are pivoted from said first position of said bottom lid to said second position of said bottom lid, and add located in said bottom lid is pressed by said top lid toward said egg cracking element and is cracked by said egg cracking element.

2. An egg cracking apparatus as defined in claim 1, wherein said base has an opening, so that when the egg is cracked egg shells are retained in said base, while yoke and white flows through said opening.

3. An egg cracking apparatus as defined in claim 1, wherein said base has a bent flange adapted to be fitted on a container.

4. An egg cracking apparatus as defined in claim 3, wherein said bottom lid has a bent flange adapted to be fitted on and surround said bent flange of said base.

5. An egg cracking apparatus as defined in claim 2, wherein said egg cracking element extends over a predetermined distance in said base, while said opening in said base is formed in an area in which said egg cracking element does not extend.
